(19) United States
(12) Patent Application Publication
(10) Pub. No.: US 2001/0033666 A1
(43) Pub. Date: Oct. 25, 2001

(54) Portable audio mixer

(76) Inventor: Ram Benz, Richmond Hill, NY (US)

Correspondence Address: Steven E. Shapiro, Esq., MITCHELL, SILBERBERG & KNUPP LLP, 11377 West Olympic Boulevard, Los Angeles, CA, 90064, US

(21) Appl. No.: 09/775,389

(22) Filed: Feb. 1, 2001

Related U.S. Application Data
(60) Provisional application No. 60/179,636, filed on Feb. 1, 2000.

(51) Int. Cl. H04B 1/00

(52) U.S. Cl. 381/119

(57) ABSTRACT

The present invention is a hand-held device that includes an elongated case, said case having a circumference of less than 5 inches, a first audio signal input, a second audio signal input, means for mixing signals received by said two audio signal inputs, and a first audio output operatively connected to said means for mixing signals. In its typical configuration, the elongated case comprises a first end and a second end and each of said first audio signal input, second audio signal input and first audio output is located at said first end. The typical configuration also includes a second audio output operatively connected to said means for mixing signals is located at said second end.

This patent application is based on and claims priority of U.S. Provisional Patent Application Ser. No. 60/179,636, filed Feb. 1, 2000.

### FIELD OF THE INVENTION

The present invention relates to electronic devices for mixing audio signals.

### SUMMARY OF INVENTION

The present invention is a versatile, compact, palm-sized, independent Microphone/Portable Audio Player mixer. Preferably, the present invention can be used to mix the audio output signal from a portable audio player (e.g., CD player, cassette player, portable radio, camcorder, drum machine and rhythm box, Hi Fi system, or boom box) with the signal from any microphone (or a second line level input) to 1 or 2 pairs of headphones and to an additional line level stereo output, making it possible to record the personal mix.

Personal or component audio sound source levels are adjustable from the sound source and microphone levels (or level of a second line level input) are adjustable by a built in fader, which allows the user independent control of the music and mic levels for a personal mix. This mix can be monitored and heard with one or two pairs of headphones and recorded at the same time by any other recorder (even a camcorder or computer) of choice, for the creation of personal tapes, mixes, soundtracks, sound files, presentations, performance, rehearsals and many other applications.

The present invention's versatility, adaptability and optional accessories, miniature size and robust construction make it a useful unique portable/personal audio tool, which in the hands of a creative user, or audio enthusiast of any level, can be used to produce results that normally require the use of separate, dedicated and expensive recording equipment found usually in recording studios or expensive platform/PC dependent software and hardware combinations.

The present invention, in the preferred embodiment, includes a unique high quality “plug in” electret microphone capsule, which is cordless and will detach easily, making its input available for a wide variety of other microphones (dynamic, unidirectional, hand held, wireless, etc.), depending on the user's specific application and needs. This input can also be used as an additional line level input.

The present invention can, if desired, effectively remove vocals from tapes and CDs allowing ideal accompaniment for the user's personal sung or spoken voice, without the interference of the original vocal. Vocal suppression is a switchable option (on/off) yielding unique high quality optimum simulated stereo results. The present invention, in the preferred embodiment, further offers reverb/delay as switchable options (in/out) that enhance and add an extra dimension and depth to the added vocals or that input.

The present invention is plugged in between any audio sound source and a pair of headphones and can be handheld, clipped onto a belt, hung around the neck like a pendant, strapped onto the listener's wrist, mounted on any Camcorder or positioned on a table top with the supplied clip/stand. An additional output is provided for recording the mix.

### DESCRIPTION OF INVENTION

The present invention is a hand-held device that accepts multiple audio signal inputs, processes them, and provides one or more outputs. The outputs are “mixes” of the input sources. The present invention relates generally to audio, multimedia and video systems and, more particularly, the invention relates to audio mixing systems for mixing audio sources from a variety of devices in real time.

Audio mixers have been utilized in the radio, film and video industries and audio enthusiasts for many years. The audio mixer generally takes several separate audio signal sources and provides the user a means of combining them into one composite signal (stereo or mono), while allowing changing the level and/or the processing of any one or more of the individual signal sources without having any effect on the level, integrity or characteristic of the other signal sources (inputs) in the network.

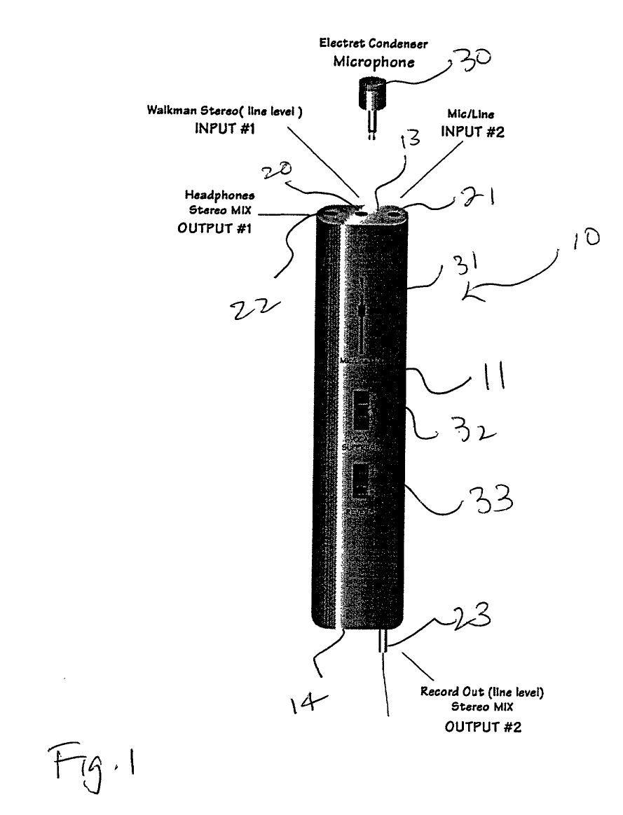

A preferred embodiment for the present invention is shown in FIG. 1. A portable audio mixer 10 is depicted therein. The portable, hand-held mixer 10 comprises a case 11 that is elongated with a first end 13 and a second end 14. Preferably, the case 11 is an elongated shape with a length of about four to eight inches and a circumference of less than four inches. The shape and size permits the portable mixer to be easily and comfortably grasped and held in hand. Generally, the portable mixer will be sized and shaped according to the size and dimensions of an average-sized adult hand, but can be made smaller or larger and still be within the scope of the present invention.

The first end 13 of the portable mixer 10 has a first input 20, a second input 21, and a first output 22. The first input 20 is to allow line level input from the audio output of any electronic device or audio source, such as, for example, a portable CD player, video camcorder, VCR, computer sound card, DVD player, portable radio or portable audio tape player. The second input 21 is to permit input from a microphone, such as an Electret Condenser Microphone (see, item 30) or a second audio line level source. The audio feed into the two inputs (20 and 21) is mixed by the circuitry within the portable mixer 10 and the result is output at first output 22. Preferably, the first output 22 is used for headphones, although it can be used for other purposes (e.g., recording into tape recorder). On the second end 14 there is a second output 23. Preferably, the second output 23 is used for recording purposes. In the preferred embodiment, the output generated in both the first output 22 and the second output 23 is the same, except that output 22 may differ electronically and have different impedances, sensitivities, amplification, power specs or voltages (to accommodate and drive a pair of stereo headphones). One output jack would supply a line level (simulated) stereo mix/signal and the other would supply the same (simulated) stereo mix/signal at headphone ready level. Placement of output jacks may be different than what is shown in FIG. 1.

Also shown in FIG. 1 are a volume adjustment potentiometer 31, a vocal suppress button 32, and a reverb button 33. The volume adjustment 31 allows volume adjustment of the signal into the second input 21. It is expected that the user would adjust the volume of the signal into the first input 20 with the portable device from which the signal is received (e.g., the portable CD player, tape player or radio). As can be seen in FIG. 1, the volume adjustment 31 shown is a slidable device wherein volume increases as the device is moved toward the first end 13. Other volume adjustment devices could be used instead, such as, for example, a turn knob or two buttons (volume up and volume down).

The vocal suppress button 32 permits the user to suppress or remove voice from the recorded material input into the first input 20. This allows the user, for example, to suppress the voice of a popular song from a portable CD player and sing into a microphone operably connected to the second input 21, thereby becoming the voice for the song.

The reverb button 33 permits the addition of reverb to the microphone input. In audio control systems such as, for example, amplifier systems utilized with musical instruments, a reverberation effect is frequently provided. This effect may be achieved by mixing the direct audio signal with a processed component (e.g., delayed component) of the signal by providing a bucket-brigade delay line with regenerative circuit to feed the output back to the input for multiple recycles or a digital delay.

Many other configurations are possible for the present invention. For example, the portable mixer 10 might have only one output, either on the first edge or the second edge. Or the portable mixer might have both the first and second outputs on the second edge. Further, the portable mixer depicted in FIG. 1 has an oblong cross-section. Instead, its cross-section might be circular, rectangular, oval or otherwise shaped. Or the portable mixer might not be elongated, but might be some other shape still appropriate for grasping by the hand of a human being (generally, as mentioned above, the device will be of a size and shape that can be comfortably held in the palm of an average-sized adult human hand, but can be smaller or larger).

Typically, in any configuration, the portable mixer will not weigh more than 8 ounces. Preferably, the portable mixer will not weigh more than 4 ounces, and even more preferably, will weigh less than 3 ounces.

Generally, the average circumference along the length of the device will be less than 5″ and preferably less than 4″. In the embodiment shown in FIG. 1, the basic dimensions of the device are roughly 4½″ (in length) by ⅝″ by 1″, with an average circumference of about 3¼″. It is most preferred that the average circumference be about 3″.

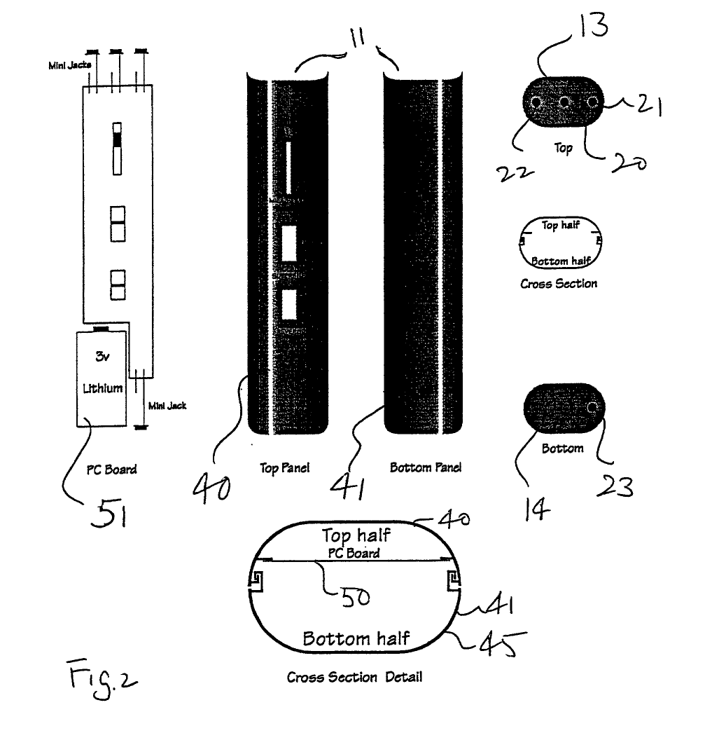

FIG. 2 provides several depictions of views of the case 11. As shown in FIG. 2, there is a top panel 40 and a bottom panel 41. The first edge 13 (or “top”) is shown with the first input 20, the second input 21 and the first output 22. Also shown is the second edge 14 (or “bottom”), with the second output 23.

A cross-section 45 of the case is also shown. Said cross section shows a top panel 40 and a bottom panel 41, as well as the location of the PC board 50 that contains the circuitry disposed within the case. Also shown is an illustration of the PC board 50 that shows the placement of the battery 51, which is preferably a 9 volt battery or other battery of similar quality (such as the 3-volt lithium shown). Note that the second input 22 is not centered in the second end 14 such that room is left for placement of the battery.

Although the embodiment shown illustrates the preferred embodiment, there are many other embodiments that are within the scope of the invention. For example, what is illustrated as a PC board 50 may actually be miniaturized to an IC chip that might be one-third the size as the PC board shown in FIG. 2, or even some smaller size.

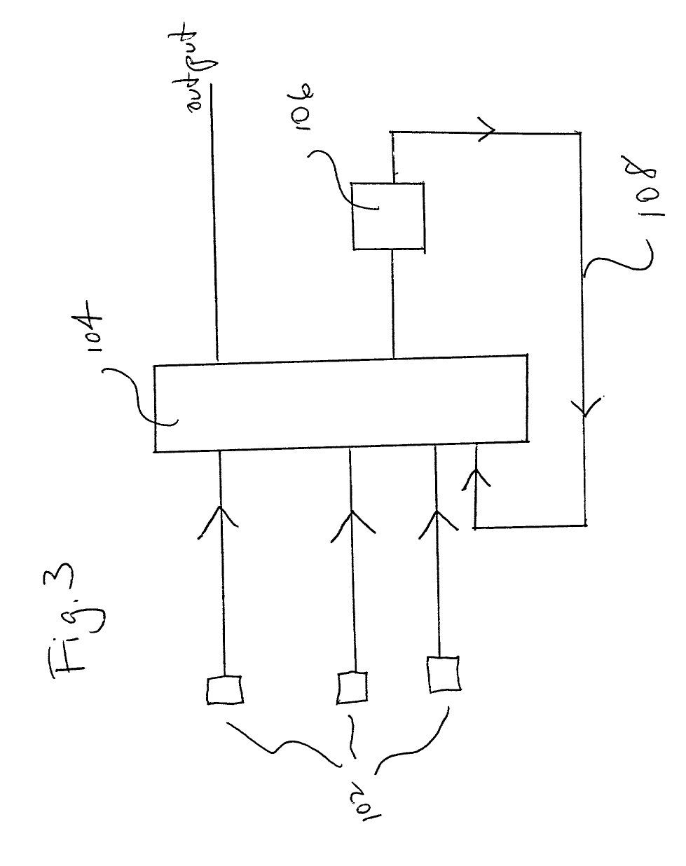

An exemplary mixer circuitry configuration 100 that can be utilized as part of the present invention is shown in FIG. 3. It includes various input channels 102 that are summed or mixed together onto a main mix bus 104. In this example, the audio signals from each input channel are also mixed together and sent to one or more effects sends 106. This signal appearing at the various effects sends 106 are processed by various effects processors whose outputs are fed back into the mixer through effects returns 108 and mixed with the audio signals fed directly onto the mixing bus 104 from the individual inputs 102. In such configurations, the effects returns are mixed onto the mixing bus 104 as if they were individual channel input signals.

Of course, other mixer circuitry can be utilized in the present invention, such as circuitry wherein audio signals from input channels are processed for special effects purposes before they are directed to the main mix bus. Note that mixer circuitry configuration 100 has more than two inputs. Of course, a portable mixer can have more than two inputs and still be within the scope of the present invention. However, a configuration with two inputs, and only two inputs, is preferred.

It is also important to note that many different types of circuitry can be utilized in a portable mixer and still be within the scope of the invention. A portable mixer can still be within the scope of the invention whether it utilizes digital technology, analog technology or both. Also, although the preferred embodiment described herein involves analog input and output, it is also within the scope of the invention for a portable mixer to have digital input and/or digital output.

In this regard, a portable mixer that falls within the scope of the present invention might comprise an MP3 encoder/decoder. A portable mixer according to the present invention might also include, for example, an RJ 11 jack for connection to a telephone in order to receive input or send output via telephone communications.

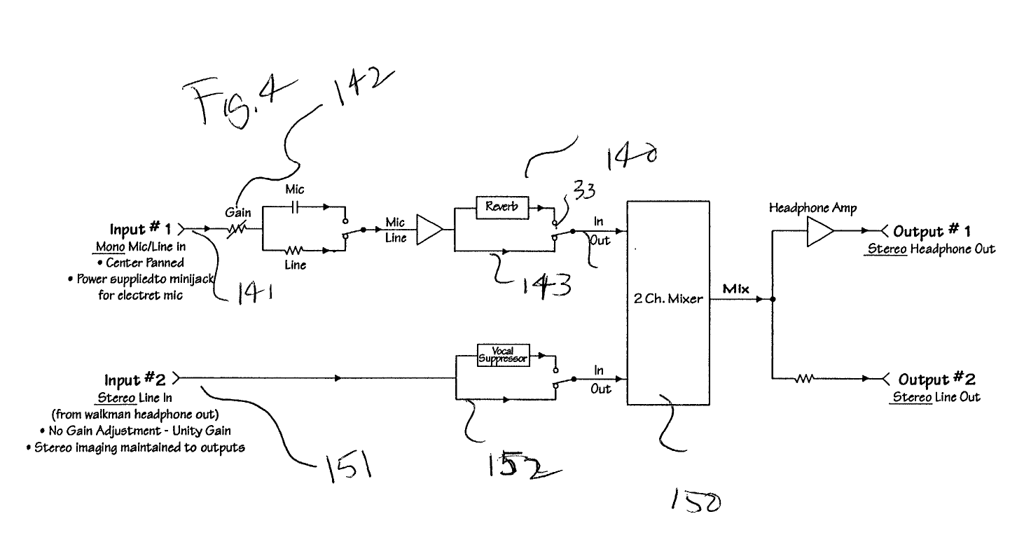

FIG. 4 illustrates a further exemplary circuitry configuration that can be utilized in the present invention. FIG. 4 provides a block diagram 140 of the basic circuits for the preferred embodiment. Shown therein is a second input 141 (mic/line), which is operationally connected to a gain device 142. The gain device provides the control over the volume of the second input. Further shown is a reverb circuit 143, which may be diverted by the reverb switch/button 33. The output therefrom is then input into a two-channel mixer 150.

Also input into the two-channel mixer 150 is signal from a first input 151. Operationally connected between these two components is a voice suppression circuit 152, which may be diverted by operation of the voice suppress button.

The audio signal of the second input 141 can be processed in order to create other special effects other than reverb. For example, a DSP-based circuit might be added between the second input 141 and the two-channel mixer 150 that provides desired special effects.

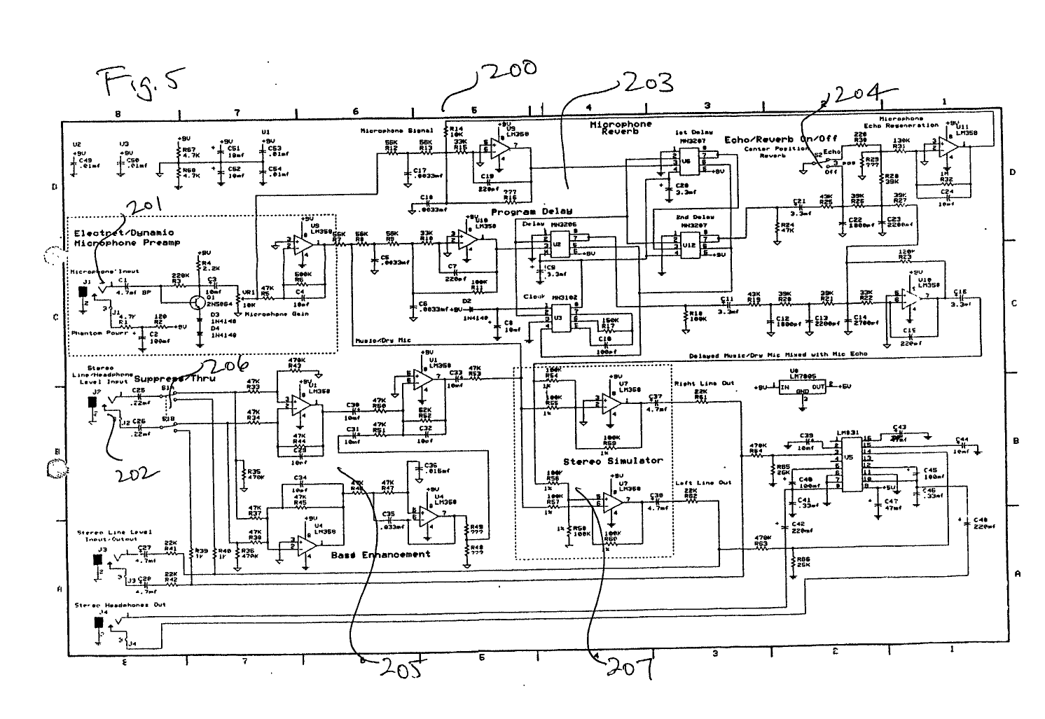

FIG. 5 provides a more detailed schematic of exemplary circuitry 200 that can be included in the present invention. Shown in FIG. 5 is a microphone input 201 and a stereo line level input 202. In the embodiment illustrated by FIG. 5, the circuit includes reverb circuitry 203 for establishing a reverb effect in the microphone input signal. The reverb effect may be switched on or off via a reverb switch 204.

The circuitry shown in FIG. 5 also provides a means for suppressing 205 for removing or reducing the voice element of the audio signal from the stereo line level input. In the analog circuitry shown, filters remove the center band of the audio signal. Similar to the reverb special effect, the suppress function can be switched on or off 206.

The circuitry of FIG. 5 also includes a stereo simulator 207. This provides for stereo simulation of an audio signal after it has gone through voice suppression. One of the artifacts of voice elimination/suppression is a mono signal. This signal, by passing it through a stereo simulation circuit, will be enhanced back to a two-dimensional signal.

Although the portable mixer will generally be handheld, the portable mixer can further comprise a clip or other means on the device to allow, for example, a person to clip the portable mixer to a belt or shirt pocket. The portable mixer can also comprise, for example, a hook to allow the mixer to be hung from some structure. The mixer might also comprise a chain or string to allow a person to hang the mixer around his or her neck (or the mixer might comprise a ring that can be strung for that purpose). Additionally, Velcro or other fastening means can also be included on the device to allow it to be secured, for example, to a belt or some structure (such as a car dashboard).

What is claimed is:

1. A hand-held device comprising:
a. An elongated case, said case having a circumference of less than 5 inches;
b. a first audio signal input;
c. a second audio signal input;
d. means for mixing signals received by said two audio signal inputs; and
e. a first audio output operatively connected to said means for mixing signals.

2. The hand-held device of claim 1 wherein said first audio output comprises a stereo jack.

3. The hand-held device of claim 2 further comprising a second audio output.

4. The hand-held device of claim 3 wherein said second audio output comprises an output for headphones.

5. The hand-held device of claim 1 wherein said elongated case comprises a first end and a second end and each of said first audio signal input, second audio signal input and first audio output is located at said first end.

6. The hand-held device of claim 5 wherein a second audio output operatively connected to said means for mixing signals is located at said second end.

7. The hand-held device of claim 1 wherein said circumference is less than four inches.

8. The hand-held device of claim 1 wherein said first audio signal input allows a line level input from the audio output of an audio source and the second audio signal input permits input from a line level signal.

9. The hand-held device of claim 8 wherein said second audio signal input permits input from a microphone.

10. The hand-held device of claim 9 wherein said first audio output is configured to accept headphones.

11. The hand-held device of claim 1 further comprising a volume adjustment that allows volume adjustment of the signal into the second input.

12. The hand-held device of claim 10 wherein there is no volume adjustment on the hand-held device for adjusting the volume of the first audio signal input.

13. The hand-held device of claim 1 further comprising a vocal suppress button that permits the user to suppress a voice from recorded material input into the first audio signal input.

14. The hand-held device of claim 1 wherein the length of the device is between eight inches and four inches long.

15. The hand-held device of claim 1 further comprising fastening means.

16. The hand-held device of claim 15 wherein said fastening means comprises a clip.

17. The hand-held device of claim 15 wherein said fastening means comprises a velcro.

18. The hand-held device of claim 15 further comprising hanging means.

19. The hand-held device of claim 18 wherein said hanging means comprises a loop of slender line.

20. The hand-held device of claim 19 wherein the loop of slender line is sufficiently large to fit over a human head.

21. The hand-held device of claim 18 wherein said hanging means comprises a hook.

22. The hand-held device of claim 1 wherein said means for mixing signals comprises a DSP chip.
